(19) United States
(12) Patent Application Publication
(10) Pub. No.: US 2013/0256234 A1
(43) Pub. Date: Oct. 3, 2013

(54) WATER TREATMENT SYSTEM FOR BUILDINGS

(71) Applicants: Jorge Miller, Houston, TX (US); Louisa Kling Miller, Houston, TX (US)

(72) Inventors: Jorge Miller, Houston, TX (US); Louisa Kling Miller, Houston, TX (US)

(21) Appl. No.: 13/431,911

(22) Filed: Mar. 27, 2012

(51) Int. Cl. E03F 5/14; C02F 1/465

(52) U.S. Cl. 210/703; 210/170.03

(57) ABSTRACT

A system and process for treatment of sewage water from a building are disclosed. The system has a source of sewage water located inside or about a building, a sewage treatment apparatus to receive and treat sewage water from the sewage water source, and a storm drain connected to the sewage treatment apparatus—where the storm drain receives treated sewage water from the sewage treatment apparatus. The sewage treatment apparatus of the system has a sparger, an electrolytic cell, and an upper section. The sparger is below the upper section and above the electrolytic cell. The process includes receiving sewage water from a sewage water source, treating sewage water in the sewage treatment apparatus, and directing the treated sewage water to a storm drain.

### TECHNICAL FIELD

This disclosure relates to treatment of sewage water and more particularly to local sewage treatment of a building.

### BACKGROUND

Sewage can be treated locally or remotely. When treating sewage remotely, sewage is typically discharged into sewer lines and treated in sewage treatment plants. These plants typically include physical, chemical, and biological processes to remove physical, chemical and biological contaminants from the water and can be costly to build and operate and take up a lot of real estate. In communities experiencing population growth, there are greater demands being placed on existing sewage treatment plants to process larger amounts of sewage being generated, and building additional sewage treatment plants to accommodate larger sewage processing capacities may not be a financially or a viable solution in some communities.

When treating sewage locally, sewage is typically treated in local systems such as septic systems. Septic systems typically consist of one or more tanks connected to an inlet wastewater pipe at one end and a septic drain field at the other. Wastewater enters the tank through the inlet pipe, the solids settle and are anaerobically digested inside the tank and the liquids flow out of the tank into the drain fields where the water is released into the soil. Septic systems require a sizeable real estate footprint for the drain field and the soil must also typically pass a percolation test. The low sewage water treatment throughput possible with septic systems typically limit septic systems to small scale sewage water treatment applications, such as treating sewage water from dwellings; making them unsuitable for uses requiring large sewage water treatment throughput such as with high-rise buildings. Septic systems can also be costly since typically a separate septic system may be required for each dwelling with the cost borne by the homeowner. In addition, septic systems may not be practical in communities with high population densities because of the sizeable footprint required for each septic system especially for the drain field for each septic system.

There is a need for a sewage treatment system that is more efficient and takes up less real estate than traditional sewage treatment systems. This disclosure addresses that need.

### SUMMARY OF THE INVENTION

In one aspect, a disclosed system for the treatment of sewage from a dwelling or a high rise building may have a sewage water source located inside or about a building, a sewage treatment apparatus to receive and treat sewage water from the sewage water source, and a storm drain connected to the sewage treatment apparatus, where the storm drain receives treated sewage water from the sewage treatment apparatus. The sewage treatment apparatus of the system may have a sparger, an electrolytic cell, and an upper section. The sparger may be below an outlet of the upper section and above the electrolytic cell, and the electrolytic cell may be connected to the sewage water source.

In another aspect, a disclosed process for the treatment of sewage water from a building may include receiving sewage water from a sewage water source located inside or about a building, passing the sewage water in a generally vertically upward direction through an electrolytic cell of a sewage treatment apparatus to form a floc, sparging the floc at a point above the electrolytic cell to cause the floc to float, separating the floating floc from the sewage water to form treated sewage water, and directing the treated sewage water to a storm drain.

### BRIEF DESCRIPTION OF THE DRAWINGS

FIG. 1 shows a functional diagram of an embodiment of the system for sewage treatment of a building.

FIG. 2 is a schematic side view of an embodiment of a sewage treatment apparatus used in the disclosed system and process for sewage treatment of a building.

FIG. 3 is schematic side view of another embodiment of a sewage treatment apparatus used in the disclosed system for sewage treatment of a building.

FIG. 4 shows a perspective view an embodiment of the system used with a house.

FIG. 5 shows a perspective view of a land use system utilizing multiple systems for sewage treatment in multiple buildings.

### DETAILED DESCRIPTION

This present disclosure relates to a process and system for the treatment of sewage water from a building. As used in this disclosure, a building refers to a structure used or intended for supporting or sheltering any use or occupancy. Buildings include without limitation residential buildings, commercial buildings, educational buildings, industrial buildings, governmental buildings, military buildings, parking and storage buildings, religious buildings, transit stations, and any other building used or intended for sheltering any use or occupancy. Buildings may have any function or form factor including ground level building, an underground building, a multi-story building, or a high rise building.

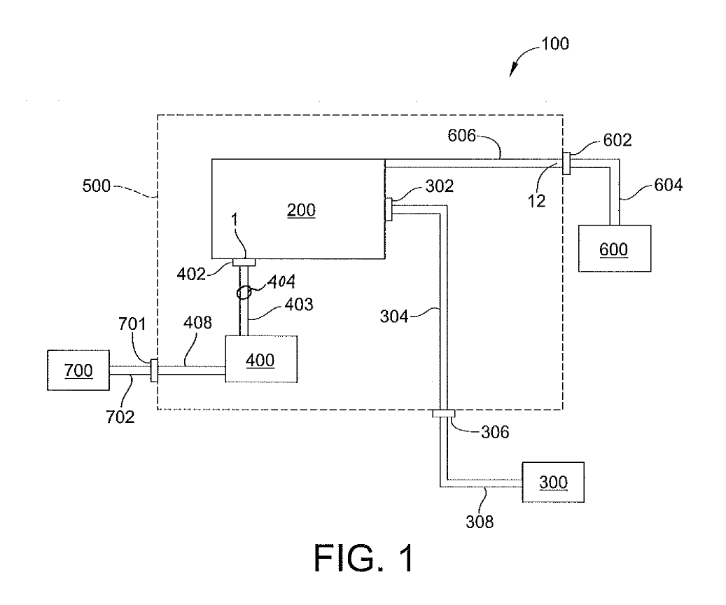

FIG. 1 shows a functional diagram of an embodiment of the system 100. The system 100 may have a sewage treatment apparatus 200, a storm drain 300, a sewage water source 400, a tank 600 for sewage sludge, and clean water source 700. The sewage treatment apparatus 200 and sewage water source 400 may be located in the footprint 500 of a building. In embodiments, the sewage treatment apparatus 200 may be located about the footprint 500 of a building.

In the disclosed system 100, clean water may flow from clean water source 700, through conduit 702 residing outside the footprint 500 of the building, and through conduit 408 residing inside or about the footprint 500 of the building for use inside the building. A coupler 701 may connect conduits 702 and 408. As used in this disclosure, a coupler refers to any connecting apparatus, adapter, valve, nozzle, and the like which two or more conduits may be connected so that fluids flowing in one conduit may flow into another conduit via the coupler. Couplers may be of any scale, whether small for connecting plumbing pipe in a bathroom, or whether connecting larger sewage lines in a multi-dwelling building, or whether connecting feeder lines in a storm drain system on a macro land-use scale, or whether connecting or adapting various sizes of lines or conduits to various other sizes of lines or conduits.

The clean water source 700 may reside outside the footprint 500 of the building. In other embodiments, the clean water source 700 may reside inside the footprint 500 of the building. The use of the clean water from the clean water source 700 may turn the clean water into the sewage water and provides the sewage water source 400 (i.e., the point where sewage water is generated in or about the building). The clean water source 700 may be any source of clean water that when used inside the footprint 500 is turned into sewage water.

The sewage water source 400 may be any point in or about the building where clean water is used and turned into sewage water. In embodiments, the sewage water comes from a sewage water source 400 from within a building by, for example, toilets, sinks, bathtubs, and showers. Sewage water may flow from the sewage water source 400 through conduit 403 into inlet 1 of the sewage treatment apparatus 200. Conduit 403 may be connected by a coupler 402 to the inlet 1 of the sewage treatment apparatus 200. A preliminary screen 404 is provided between the sewage water source and the sewage treatment apparatus to remove debris such as plastics, rubber goods, rags, toilet paper, etc. that may find their way into the sewage wager. The preliminary screen is used to remove these materials from the sewage water for separate disposal.

The sewage treatment apparatus 200 may receive and treat sewage water from the sewage water source 400. Particularly, the sewage treatment apparatus 200 may electrolytically treat and sparge sewage water to form flocs, which may then be removed from treated sewage water, as described in detail below.

Flocs, or sewage sludge, which are separated from treated sewage water in the sewage treatment apparatus 200, may flow from the sewage treatment apparatus 200 through conduits 604 and 606 to the tank 600, where the flocs are stored until removal. Conduit 606 may be located within the footprint 500 of the building, and conduit 604 may be located outside the footprint 500 of the building. A coupler 602 may connect conduits 606 and 604. The tank 600 may be located outside the footprint 500 of the building; alternatively, the tank 600 may be located inside the footprint 500 of the building. The tank 600 may be a container of any suitable size and material for storing sewage sludge for periodic removal.

Treated sewage water may flow through a treated sewage water outlet 12 of the sewage water apparatus 200 through conduit 304, and out of the footprint 500 of the building. A coupler 302 may be used to connect conduit 304 to treated sewage water outlet 12. A coupler 306 may be used to connect conduit 304 residing inside the footprint 500 of the building to conduit 308 which may be located external to the footprint 500 of the building. The treated sewage water may flow through conduit 308 into the storm drain 300 (which may be a public drain, a feeder to a storm drain system, a storm drain system, etc.).

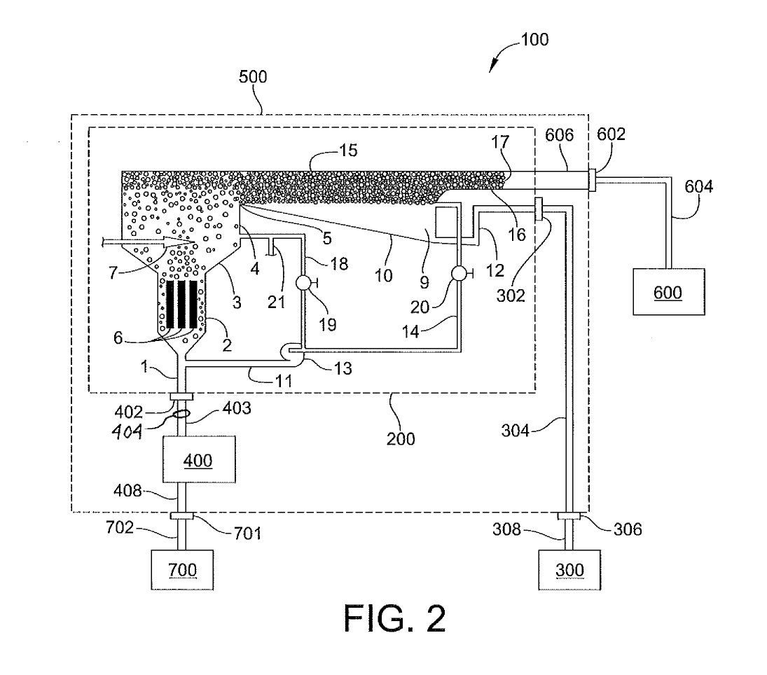

FIG. 2 is a depiction of FIG. 1 with the sewage treatment apparatus 200 shown in FIG. 2 illustrating an embodiment of a sewage treatment apparatus 200 that may be used in the disclosed system and process for sewage treatment of a building. Many of the elements shown in FIG. 2 have the same number as like elements shown in FIG. 1 and the description of those elements with respect to FIG. 1 applies to the description of like elements in FIG. 2. A discussion of the illustrative embodiment of the sewage treatment apparatus 200 now follows. The sewage treatment apparatus 200 of the system may have a sparger 7, an electrolytic cell 2, an upper section 4, and a basin 9. The sparger 7 may be below an outlet 5 of the upper section 4 and above the electrolytic cell 2, and the electrolytic cell 2 may be connected to the sewage water source 400. The basin 9 of the sewage treatment apparatus 200 may be connected to the outlet 5 of the upper section 4. The basin 9 may have a flocs outlet 16 located at a top of the basin 9 opposite the upper section 4, and the basin 9 may have the treated sewage water outlet 12 at a bottom 10 of the basin 9 opposite the upper section 4. The bottom 10 of the basin 9 may have an incline sloping away from the upper section 4, and the treated sewage water outlet 12 may be located at a lower end of the bottom 10 of the basin 9 opposite the upper section 4. The storm drain 300 may be connected to the treated sewage water outlet 12. The sewage water source 400 may be from a building 500 (shown with dashed lines).

In the sewage treatment apparatus 200, the electrolytic cell 2 may have electrodes 6 therein. Sewage water may be electrolytically treated with the electrodes 6 of the electrolytic cell 2 to produce positively charged compounds and high molecular weight organic acids, which combine to produce positively charged insoluble hydrophobic soaps. These soaps trap organic compounds and encapsulate microbes in the sewage water. The electrodes 6 may be surrounded by a moving bed of solid non-conductive hard particles whose specific density is greater than that of the sewage water.

An inlet conduit 1 of the sewage treatment apparatus 200 may be connected to the bottom of the electrolytic cell 2. The upper section 4 of the sewage treatment apparatus 200 may be positioned above the electrolytic cell 2. The upper section 4 may include a conical portion 3 connected to the top of the electrolytic cell 2. The upper section 4 may also include a recycle conduit 18. The outlet 5 is located above the conical portion 3. The recycle conduit 18 is positioned on the upper section 4 between the outlet 5 and the conical portion 3. Recycle conduit 18 may connect to the inlet of a re-circulating pump 13. Air and additional soap may be introduced through line 21 into the recycle conduit 18. Additional soluble soaps may be introduced in some embodiments, particularly where the amount of high molecular weight organic acids or esters are insufficient in the sewage water to form positively charged metallic soaps for coagulation. Due to the pressure supplied by the pump 13, the air and soap which may be added through line 21 generally may be compressed and dissolved to form micro-bubbles in the electrolytic cell 2.

In the sewage treatment apparatus 200, electrodes 6 may be mounted in electrolytic cell 2 in any suitable way. The electrodes 6 may be connected in series to a direct current source which changes polarity continuously. The change in polarity of the current ensures the equal corrosion of the electrodes 6 and enhances the cleaning action of the moving bed of solid non-conductive hard particles.

In embodiments, the frequency of change in polarity may be in equal periods of time. The use in this disclosure of continuously” refers to changing the polarity between about 1 change per 1 second to about 1 change per 10 minutes and is dependent upon the amount of sewage in the sewage water and the tendency of sewage to accumulate on the electrodes. The electrodes 6 may be corrodible and made of, but not limited to divalent or trivalent metals, such as, aluminum, iron, magnesium or their combination or alloys.

In embodiments, the sparger 7 may be located at the top of the conical portion 3, above the point where the moving bed of solid non-conductive hard particles has settled, but still below the surface level of electrolytically treated sewage water. “Sparger” herein refers to an air blower which may be positioned within the electrolytically treated sewage water that has passed through the electrolytic cell 2, so as to blow air bubbles through the electrolytically treated sewage water. The sparger 7 may supply additional bubbles besides those formed during electrolysis to the upper section 4. The sparger 7 may be connected to a compressed air supply (not shown). The sparger 7 may produce bubbles which float the flocs produced by the release of metallic soaps during the electrolysis of the sewage water. The sparger 7 may introduce air bubbles into the electrolytically treated sewage water above the electrolytic cell 2 after the sewage water is treated in the electrolytic cell 2. Also, the sparger 7 may introduce air bubbles into the electrolytically treated sewage water below the outlet passage 5 of the upper section 4.

Although a conical portion 3 of the upper section 4 of the sewage treatment apparatus 200 is shown in FIG. 2, any cross-section may be used which decreases the upward moving velocity of the electrolytically treated sewage water to a value where the solid non-conductive hard particles settle down into the electrolytic cell 2. The solid non-conductive hard particles may have a free-falling velocity in the sewage water which is higher than the upward moving velocity of the sewage water entering the electrolytic cell 2 of the sewage treatment apparatus 200 through inlet conduit 1 from the sewage water source 400. The flow through the sewage treatment apparatus 200 may allow any solid non-conductive hard particles which are carried away from the moving bed to return to the electrolytic cell 2.

Referring still to FIG. 2, outlet 5 of the upper section 4 may be connected to basin 9. A recirculating conduit 11 may be positioned near the upper edge of the basin 9 opposite from the outlet 5. The flocs outlet 16 may be located to allow acceptable separation of the floc and the treated sewage water. Recirculating conduit 11, along with recycle conduit 18, may be fed to recirculating pump 13. The outlet 14 of the recirculating pump 13 may be connected to the inlet conduit 1 below the electrolytic cell 2. Basin 9 may also include a flocs outlet 16 which is located above the recirculating conduit 11. The recirculating conduit 11 may be located near or below the layer of flocs 15 in order to catch any settling floc and recycle it to the electrolytic cell 2. The recirculating conduit 11 helps prevent flocs from settling to the bottom 10 of the basin 9 and flowing through the treated sewage water outlet 12.

Both upper section 4 and basin 9 of the sewage treatment apparatus 200 may be closed to the atmosphere. In practice, it has been found that exposure to the atmosphere dries out and bursts the bubbles and the flocs tend to settle, making it difficult to obtain treated sewage water free of flocs. The closed environment protects the bubbles carrying the flocs against drying and bursting. The bubbles are also drained of excess water and delivered through the flocs outlet 16 to the atmosphere. In embodiments, basin 9 may have a size so that sewage water being treated in the basin 9 has a residence time in the basin 9 of approximately 10 minutes, 15 minutes, or 20 minutes. The basin 9 may have a size for whatever residence time is necessary for separation of treated sewage water and flocs.

During operation, sewage water may flow into the sewage treatment apparatus 200 through inlet conduit 1 and upward into the electrolytic cell 2 where the sewage water is treated. In embodiments, to treat the sewage water, the sewage water may pass through the electrolytic cell 2 in a generally vertical upward direction so as to form a floc. In embodiments, the sparger 7 may sparge the floc at a point above the electrolytic cell 2 to cause the floc to float in the upper section 4 of the sewage treatment apparatus 200. In embodiments, the sparger 7 may sparge the floc below the outlet 5 of the upper section 4 of the sewage treatment apparatus 200. In embodiments, the floc may float in the upper section 4 above the sparger 7. In embodiments, the sparger 7 may sparge the floc with air. After sparging and floating in the upper section 4, the floc then floats through the outlet 5 of the upper section 4 so as to pass into the basin 9, where the floating floc may be separated from the sewage water to form treated sewage water. The treated sewage water may then be directed to a storm drain 300 through the treated sewage water outlet 12.

Referring still to FIG. 2, high molecular weight organic acids combined with metallic ions may be released from the electrodes 6 of the electrolytic cell 2 to form positively charged insoluble hydrophobic soaps which trap organic compounds and encapsulates microbes. These positively charged compounds neutralize the negatively charged colloids permitting the colloids to coalesce, making filtration or separation possible. A floc is formed through the build-up of colloidal hydrated oxides of the separated metal ions. The floc binds, or absorbs, other impurities present in the sewage water and serves as a transport medium to separate sewage impurities from sewage water.

In the moving bed, solid non-conductive hard particles may move at various speeds in various directions, by way of the water flow and gasses produced in the electrolytic cell 2, against and along the surfaces of the electrodes 6 of the electrolytic cell 2, which cleans the electrodes 6. The electrodes 6 may also be cleaned by the return motion of the solid particles non-conductive hard particles which have been carried along with sewage water and which move past the electrodes 6 as they settle downward.

The sewage water may pass through the moving bed of non-conductive hard particles in the electrolytic cell 2 via the inlet water pressure. In some embodiments, the pressure may be provided by the re-circulating pump 13. In other embodiments, air may be blown into the moving bed to intensify motion. In alternate embodiments, additional air is provided by supplying air into the suction side of the re-circulating pump 13 via line 21.

Electrolytically treated sewage water containing flocs and air bubbles may flow through outlet 5 to basin 9. Treated sewage water may flow from the basin 9 via treated sewage water outlet 12 which may be at a level below that of the flocs layer 15. Recirculating conduit 11 and recycle conduit 18 may recycle electrolytically treated sewage water and treated sewage water with flocs through pump 13 and conduit 14 to inlet conduit 1 of the sewage treatment apparatus 200. Recycle conduit 18 may recirculate the upper layer of water in the conical portion of the electrolytic cell through the electrodes.

Some embodiments may include valve 19 and valve 20 which may be used to control the flow through recycle conduit 18 and recirculating conduit 11, respectively.

Separated flocs 17 may flow through flocs outlet 16 to the atmosphere. The separated flocs 17 may contain substantially all of the impurities of the sewage water from the sewage water source 400. These flocs 17 are hydrophobic and easy to dry and handle. In some embodiments, flocs 17 may be used as fertilizer after being sterilized. In alternate embodiments, the flocs 17 may be dried and used as fuel.

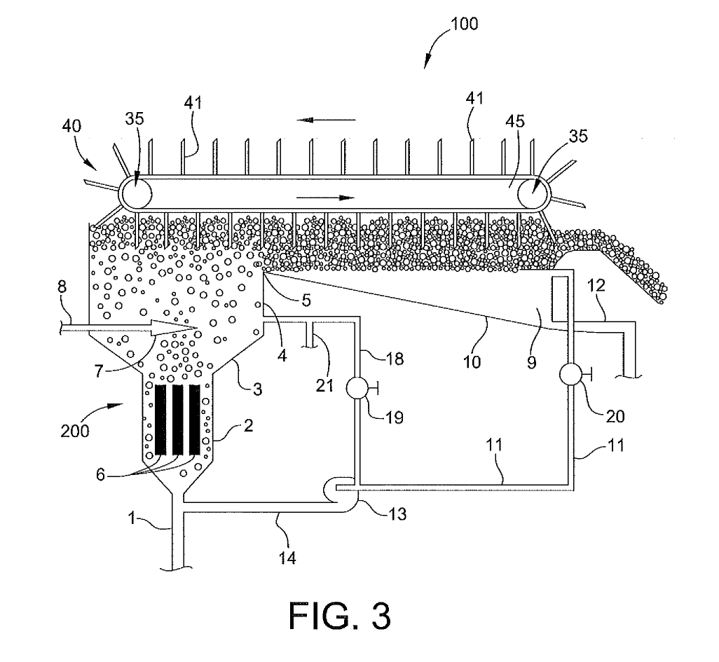

FIG. 3 shows another embodiment of the sewage treatment apparatus 200 used in the disclosed system and process for sewage treatment of a building. In the embodiment shown in FIG. 3, the sewage treatment apparatus 200 includes a conveyor 40 with downwardly depending flaps 41 which may sweep at or near a surface 42 of the treated sewage water 19 in the basin 9, and therefore sweep any floating flocs 15 at or near the surface 42 towards the flocs outlet 16. The conveyor 40 may have a conveyor belt 45 which rotates about two points 35. The conveyor 40 may be mounted overhead or on the side of the basin 9. In embodiments, the downwardly depending flaps or fins 41 may sweep the entire length of the surface 42. In other embodiments, the conveyor may also sweep only a portion of the length of the surface 42.

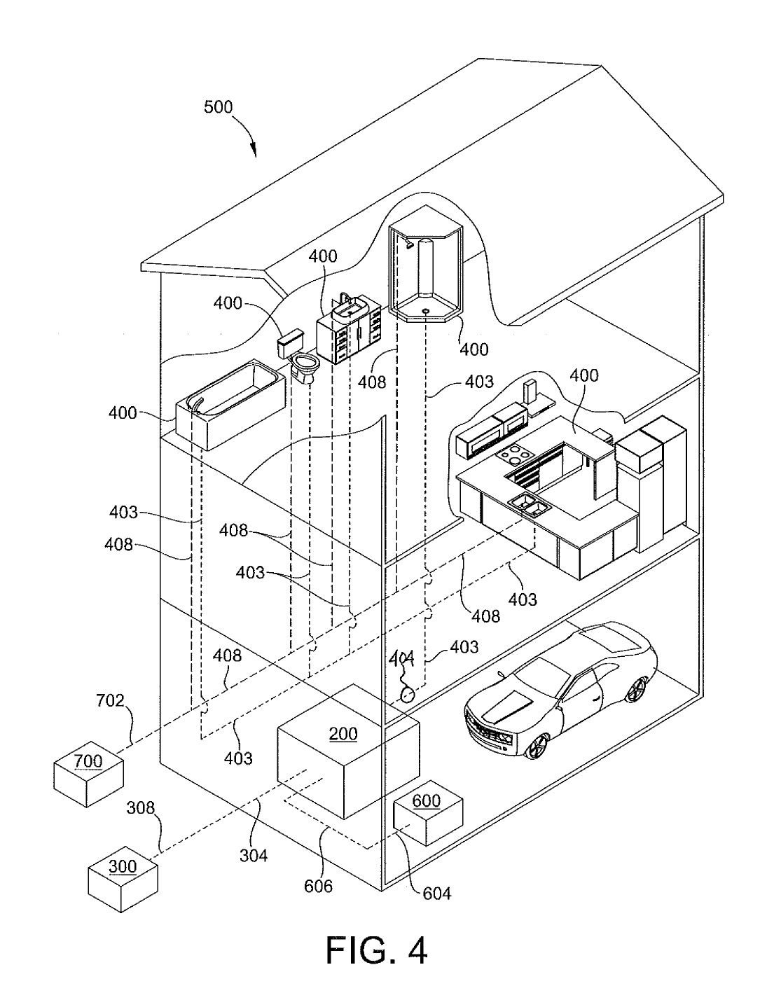

FIG. 4 shows an embodiment of the disclosed system 100 for sewage treatment of a building, as used in a dwelling. It can be seen clean water source 700 residing outside the footprint 500 of the dwelling delivers clean water to the dwelling through conduit 702. Alternatively, clean water source 700 may reside inside the dwelling. Clean water flows in the dwelling through conduits 408 to various sewage water sources 400, which are shown on the second and third floors of the dwelling in FIG. 4 as a bathroom sink, a toilet, a bathtub, a shower, and a kitchen sink. Conduits 403 connect the sink, toilet, bathtub, shower, and kitchen sink (i.e., sewage water sources 400) to the sewage treatment apparatus 200. A preliminary screen 404 is configured between conduits 403 and the sewage water treatment apparatus 200 to remove debris from the sewage water for separate disposal as previously described.

Tank 600 can be seen connected to the sewage treatment apparatus 200 on the ground floor of the dwelling. Alternatively, tank 600 may be located outside the dwelling. Conduit 702 lies externally to the dwelling in FIG. 4 and may be part of a public water utility conduit system of which the water source 700 may be a part. Conduit 308 residing outside the dwelling and conduit 304 residing inside the dwelling may connect the sewage treatment apparatus 200 to the storm drain 300. Couplers may be used to connect conduits in FIG. 4 as described above.

The sewage treatment apparatus 200, tank 600, and the sewage water source 400 are within the footprint 500 of the dwelling in FIG. 4. In alternative embodiments, the sewage treatment apparatus 200, sewage water source 400, or tank 600 may be located outside of the dwelling. In alternative embodiments, the sewage treatment apparatus 200 or tank 600 may be located in the basement of a high rise or house, or in a garage of a house or a high-rise building. Tank 600 may contain sewage sludge (the flocs) that must be periodically removed. For example, the sewage sludge may be disposed of at a refuse site, or sewage sludge may be used for other purposes such as fertilizer or fuel. Illustratively, tank 600 may be a portable container that may be transported to a disposal site for this purpose.

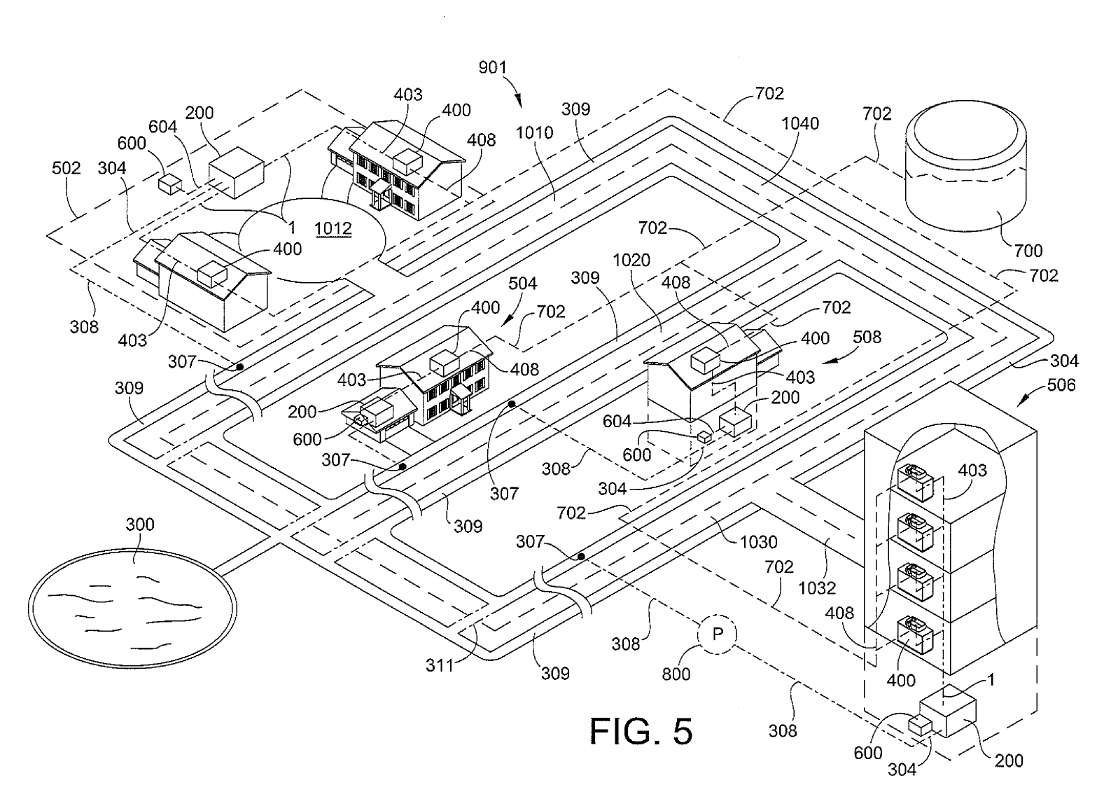

FIG. 5 shows use of several of the disclosed systems in land use planning. Each system has a footprint for a building as shown in FIG. 4. Clean water is delivered to buildings in conduit 702 from clean water source 700. Clean water is used in the buildings and sewage water is created in toilets, sinks, bathtubs, showers, etc. that may make up the sewage water source 400. Sewage water flows from the sewage water sources 400 through conduits 408 to sewage treatment apparatuses 200, where treated sewage water is recovered and flows through conduits 308 to the storm drain 300. As discussed in connection with previous figures, a preliminary screen (not shown) is provided between the sewage water source and the sewage treatment apparatus to remove debris from the sewer water.

Flocs, or sewage sludge, flow from the sewage treatment apparatuses 200 to the tank 600 through conduit 604.

FIG. 5 shows a perspective view of a land-use system utilizing multiple systems for sewage treatment in multiple buildings. In FIG. 5, the disclosed land-use system and process are shown to reside in a multi-dwelling community 901 shown as streets 1010, 1020, and 1030 with a cul-de-sac 1012 and a side street 1032. Buildings include houses in footprint 502, a house in footprint 504, a house in footprint 508, and a high-rise office building in footprint 506. The buildings are supplied with clean water from clean water source 700 through conduits 702, and conduits 408 deliver clean water to sewage water sources 400. Each building has a sewage water source 400 where clean water is turned into sewage water, and sewage water flows from the sewage water sources 400 through conduits 403 to the inlet 1 of respective sewage treatment apparatuses 200. The sewage water is treated by the sewage treatment apparatuses 200, and treated sewage water flows from the apparatuses 200 through conduits 304 within the buildings, then through conduits 308 outside the buildings. Couplers 307 may connect conduits 308 with feeder lines 309 of a storm drain, and treated sewage water may flow from conduits 308 into feeder lines 309 via couplers 307, and into the storm drain 300. Flocs, or sewage sludge, flow from sewage treatment apparatuses 200 to tanks 600. In footprint 502, the sewage sludge flows through conduit 604 from the sewage treatment apparatus 200 to tank 600.

On the cul-de-sac, the footprint 502 includes two dwellings, and the sewage treatment apparatus 200 and tank 600 for both dwellings are located outside the dwellings as a shared sewage treatment apparatus 200 by both dwellings. In another planned use, the sewage treatment apparatus 200 and tank 600 are shown to reside inside the garage of a house in footprint 504. In another planned use, the sewage treatment apparatus 200 is shown to reside in a basement of a house in footprint 508. In another planned use, the sewage treatment apparatus 200 is shown to reside in the basement of an office building in footprint 506. In this case a pump 800 is used to pump the treated sewage water through conduit 308 for carrying of the treated water to the storm drain 300. Alternatively, the sewage treatment apparatus 200 of the office building may be located at ground level or above ground level, limiting the size of or eliminating the need for a pump. The land-use planning uses possible with the system and process of this disclosure shown in FIG. 5 are illustrative only. Those skilled in the art will appreciate that the concepts and specific embodiments disclosed in the foregoing description may be readily utilized as a basis for modifying or designing other embodiments for carrying out the same purposes of the present invention. For example, in planned uses, the sewage treatment apparatus 200 and tank 600 may both be located outside the dwellings or office building. As another example, the sewage treatment apparatus 200 may be located inside the building and the tank 600 located outside the building. As yet another example, the sewage treatment apparatus 200 and tank 600 may be collectively or individually located on different levels of the building.

The location of tank 600 may illustratively be located to allow for easy removable of the sludge that over time is collected in the tank. To improve the aesthetic appearance of a sewage treatment apparatus 200 and/or a tank 600 located outside the building, the outside located water treatment apparatus 200 and/or the tank 600 may themselves be covered with a building or landscaping may be provided to blend them more into the surrounding environment.

The size and dimension of a water treatment apparatus for use in a particular application disclosed herein may be dependent on the volume of waste water that is produced in the building in which the water treatment apparatus is used. Thus, a water treatment apparatus in a high-rise building may necessarily be larger in scale to process the large volume of waste water that may be generated in the building on account of the larger occupancy in the high-rise building. On the other hand, a water treatment apparatus for use in a dwelling may be small in scale since there is a smaller amount of sewer water to treat on account of the lower occupancy of that building.

In one illustrative example, the size of a treatment apparatus for use in a house may be the size of a washing machine or a dryer. As yet another example, the water treatment apparatus may be provided in a closed container which is sealed to the environment in order to prevent accidents from access to the inner workings of the water treatment apparatus such as the moving conveyor belt, if the apparatus is a type that is operating with a conveyor belt; the electrical parts inside the machine, as well exposure to the sludge and contaminants that are floated to the surface and removed into a separate tank for disposal. Enclosure of the apparatus also creates a more hygienic apparatus that is healthier to the occupants, more practical, and may be more aesthetically pleasing. An enclosed apparatus may capture the gases and smells. These gases and smells may be connected to a vent system such as vent pipe for venting of these gases and smells outside of the house. Such an enclosed apparatus advantageously allows the disclosed system to be located almost anywhere inside the house, such as in a closet, or in the garage. A configuration of the dislosed water treatment apparatus for use in the disclosed system may have a form factor like an appliance that may be used inside a dwelling, such as a washer and a dryer; and the disclosed water treatment apparatus may thus be used as another household appliance.

The land use water treatment system of this disclosure may provide even further increased efficiencies and decreased costs for occupancies of buildings. For example, in the restaurant and in other businesses that generate a high concentration of pollutants in the sewer water, these businesses are often required to pay higher sewer water treatment costs in order to pay for the higher water treatment costs incurred by water treatment facilities to treat these more polluted sewer water. Many businesses may also incur fines for the dumping of more concentrated sewer water into public sewer systems that exceed the sewer water treatment rules that are allowed by the water treatment provider. If a business is unable to treat the sewer water into the allowed quality that meets these standards, these businesses may even be prohibited from using the water treatment services or have to pay a fine. The water treatment tool of this disclosure provides these businesses and others with an effective and efficient system for treating sewer water on-site to satisfy all of these requirement, leading to reduced costs and fines for these businesses and others.

This example illustrates yet another important aspect of the disclosed water treatment system. Whereas, in previous examples, the treated water is directed into a storm drain system, in this example, the treated water is treated to a quality sufficient for the direction of the treated water into a sewer line system.

### INDUSTRIAL APPLICABILITY

The industrial applicability of the disclosed system and process is evident from the disclosure above. A building may be provided with a sewage treatment apparatus 200 to receive sewage water from or about units in the building and to direct treated sewage water to a storm drain; thereby, creating a system for localizing the treatment of sewage water at or about the site of the water sewage source that is an alternative to traditional local sewage treatments such as septic systems and to remote community based sewage treatment at a sewage treatment plant.

The disclosed system receives sewage water from a sewage water source in a building and treats the sewage water simply and efficiently with an electrolytic cell and sparger to separate flocs formed from the treatment as opposed to traditional systems for treating community water involving oxidation and settling tanks or septic systems. Advantageously, the treated sewage water flowing from the disclosed system may be discharged directly into existing storm drains instead of directing raw sewage of the building to sewage lines. Thus, buildings utilizing the disclosed system have local treatment of sewage water, have no sewage lines cost, recycle treated sewage water through the storm drains, and create valuable flocs which have various uses and value. The waste footprint of the building thus may be reduced.

The disclosed process for sewage treatment of a building illustratively involves receiving sewage water from the building, treating the sewage water in the disclosed sewage treatment apparatus, and directing the treated sewage water to a storm drain.

By providing buildings with a local sewage treatment process, local treatment of the sewage water from the building takes strain off of remote sewage treatment plants in high-population density areas.

Additionally, local sewage treatment according to the disclosed system and process may supplement or replace traditional local and remote sewage treatments to provide a more robust selection of processes and system for sewage treatment needs.

Moreover, the disclosed system and process for treating sewage water provides a water treatment solution that enables land use planning not available using conventional remote water treatment systems and on-site septic systems. The water treatment system and process of this disclosure provides a valuable land use planning tool; bringing a cost-effective and efficient water treatment solution directly to the site of the water treatment need at or about a building that produces the sewage water requiring treatment as discussed above.

Those skilled in the art will appreciate that the concepts and specific embodiments disclosed in the foregoing description may be readily utilized as a basis for modifying or designing other embodiments for carrying out the same purposes of the present invention. Those skilled in the art will also appreciate that such equivalent embodiments do not depart from the spirit and scope of the present invention as set forth in the appended claims.

1. A system for the treatment of sewage water from a building configured for shelter or occupancy, said system comprising:
a source of sewage water operating under the influence of gravity located inside or about said building;
a sewage treatment apparatus located inside or about said building and having a sparger, an electrolytic cell, and an upper section;
said sparger being below an outlet of said upper section and above said electrolytic cell, said electrolytic cell connected to said sewage water source; said sewage treatment apparatus receiving and treating sewage water from said sewage water source; and
a storm drain connected to said sewage treatment apparatus for receiving treated sewage water from said sewage treatment apparatus.

2. The system of claim 1 wherein said building is taken from the group consisting of residential buildings, commercial buildings, educational buildings, industrial buildings, governmental buildings, military buildings, parking and storage buildings, religious buildings, transit stations, and any other building used or intended for sheltering any use or occupancy.

3. The system of claim 2 wherein said source of sewage water is taken from the group consisting of a toilet, a sink, a bathtub, or a shower.

4. The system of claim 2 wherein said sewage treatment apparatus is located inside said building.

5. The system of claim 2 wherein said sewage treatment apparatus is located outside said building.

6. The system of claim 5 wherein said building is a ground level building, an underground building, a multi-story building, or a high rise building.

7. The system of claim 1 wherein said sewage treatment apparatus has a basin connected to said outlet of said upper section, wherein said basin has a flocs outlet located at a top of said basin opposite said upper section, said basin having a treated sewage water outlet at a bottom of said basin opposite said upper section.

8. The system of claim 7, wherein said bottom of said basin has an incline sloping away from said upper section, wherein said treated sewage water outlet is located at a lower end of said bottom opposite said upper section.

9. The system of claim 7, wherein said sewage treatment apparatus has a conveyor having downwardly depending flaps positioned to sweep at or near a surface of said treated sewage water in said basin, said flaps adapted to sweep any flocs at or near said surface towards said flocs outlet.

10. The system of claim 9, further comprising:
a tank connected to said flocs outlet of said sewage treatment apparatus for receiving said any flocs at or near said surface towards said flocs outlet swept to said flocs outlet by said conveyor.

11. The system of claim 1, further comprising:
a clean water source connected to said sewage water source.

12. A process for the treatment of sewage water from a building configured for shelter or occupancy, said process comprising:
receiving sewage water from a sewage water source operating under the influence of gravity located inside or about a dwelling or a high building;
passing the sewage water in a generally vertically upward direction through an electrolytic cell of a sewage treatment apparatus located inside or about said building to form a floc;
sparging said floc at a point above said electrolytic cell to cause said floc to float;
separating said floating floc from said sewage water to form treated sewage water; and
directing said treated sewage water to a storm drain.

13. The process of claim 12 wherein said building is taken from the group consisting of residential buildings, commercial buildings, educational buildings, industrial buildings, governmental buildings, military buildings, parking and storage buildings, religious buildings, transit stations, and any other building used or intended for sheltering any use or occupancy.

14. The process of claim 12 wherein said source of sewage water taken from the group consisting of a toilet, a sink, a bathtub, or a shower.

15. The process of claim 12 wherein said sewage treatment apparatus is located inside said building.

16. The process of claim 12 wherein said sewage treatment process is located outside said building.

17. The process of claim 16 wherein said building is a ground level building, an underground building, a multi-story building, or a high rise building.

18. The process of claim 12 further comprising the step of directing said floating floc separated from said sewage water into a tank.

19. The process of claim 18 further comprising the step of connecting a source of clean water to the sewage water source.

20. The process of claim 12 further comprising the step of:
connecting a tank to a flocs outlet of said sewage treatment apparatus, the flocs outlet adapted for receiving any flocs at or near a surface of said treated sewage water, said any flocs at or near said surface swept to said flocs outlet by a conveyor.
